(19) United States
(12) Patent Application Publication
(10) Pub. No.: US 2009/0114294 A1
(43) Pub. Date: May 7, 2009

(54) PORTABLE GAS SHOCK OR AIR BAG INFLATOR OR DEFLATOR

(75) Inventor: Ryan Wallace, El Dorado Hills, CA (US)

Correspondence Address: JOHN P. O'BANION;O'BANION & RITCHEY LLP, 400 CAPITOL MALL SUITE 1550, SACRAMENTO, CA, 95814, US

(73) Assignee: RUBICON MANUFACTURING, INC., Rancho Cordova, CA (US)

(21) Appl. No.: 12/257,940

(22) Filed: Oct. 24, 2008

Related U.S. Application Data
(60) Provisional application No. 60/982,424, filed on Oct. 25, 2007.

(51) Int. Cl. F03B 11/00

(52) U.S. Cl. 137/561 R

(57) ABSTRACT

An apparatus for hand held inflating or deflating gas shocks or air bags is disclosed that is substantially hand held. A body comprises a high pressure valve, a lower pressure vent valve, and a pressurized plenum between the two valves. A high pressure gas source is connected tot the high pressure valve on one side. An object to be pressurized is connected to the other side to the lower pressure pressurized plenum. A gage is optionally available to monitor the pressure of the object to be pressurized. This device, which may fit into traditionally glove compartments and tool boxes, allows for quick and accurate pressurization of gas filled devices with pressure tunable characteristics. Although described here with a standalone highly pressurized gas source, a standard pressure disconnect can allow the device to be used with conventional tire inflation and deflation with an external pump supplying the high pressure source.

### CROSS-REFERENCE TO RELATED APPLICATIONS

This patent application claims benefit of priority to U.S. provisional patent application 60/982,424, filed Oct. 25, 2007, which is hereby incorporated by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to gas shocks or air bags, more particularly to conveniently pressurized gas shocks or air bags, and still more particularly to devices for readily changing the pressure in pressurized devices.

2. Description of Related Art

Gas filled shock absorbers, and air bags, are used to vary the riding conditions of a vehicle under large changes in loading conditions. Typically, changing the pressures in these devices is not easy, as one must find nitrogen or another gas source, and apply this pressurized source to the device in a controlled manner so as to not rupture the device. In high performance off-road conditions, this need is exacerbated, since gas filling facilities are scarce or nonexistent.

Furthermore, in bicycling, flat tires are frequently encountered when using pneumatic tubes. Such frequent flats give rise to bulky pumps for reinflating patched flat tires. These pumps are another source of weight that would most desirably be reduced.

### BRIEF SUMMARY OF THE INVENTION

An aspect of the invention is a hand held apparatus for pressurizing gas shocks or air bags, comprising: an object to be pressurized; and a means for pressurizing the object. The object to be pressurized may comprise a gas shock, an air bag, or other component requiring accurate fill pressures, such as tires or other pneumatic leveling devices. Additionally, brake lines may be pressurized to assist in brake bleeding procedures.

Without limitation, the object may be substantially pressurized with a gas selected from a group of gasses consisting essentially of: helium, argon, nitrogen, argon, carbon dioxide, dry air, a refrigerant, and one or more of the preceding. Nothing in this application precludes pressurization by other, more expensive gasses such as Xenon or Helium, or flammable gasses, such as hydrogen or methane.

Typically, the attachment to the object to be pressurized is hose terminated with a Schrader or Presta valve, although it is not limited to these types of valves.

The means for pressurizing the object may comprise a hand held unit comprising: an attachment to the object to be pressurized at a pressure outlet; and an attachment to a highly pressurized gas source.

The hand held unit may comprise: a. a vent valve that fluidly and displaceably connects a pressurized plenum to an ambient atmosphere, the pressurized plenum fluidly connected to the pressure outlet; b. a vent actuator that displaces the vent valve, thereby causing actuation of the vent valve with a consequent flow of gas from the pressurized plenum to the atmosphere; c. a high pressure inlet section, comprising: i. a high pressure valve fluidly and displaceably connected between the highly pressurized gas source and the pressurized plenum, whereby a flow of high pressure gas from the highly pressurized gas source to the pressurized plenum is allowed during actuation of the high pressure valve; ii. a high pressure valve actuator that displaces the high pressure valve, thereby causing displacement and actuation of the high pressure valve.

The hand held apparatus above may further comprise a pressure gage capable of indicating the pressure of the object to be pressurized in fluid connection with the pressurized plenum. In this manner, the means for pressurizing the object may comprise a pressure gage capable of indicating the pressure of the object to be pressurized.

The hand held apparatus for pressurizing the object above may have as the means for pressurizing the object comprising: a. means for inflating the object to be pressurized; and b. means for deflating the object to be pressurized.

In another aspect of the invention, a method for hand held pressurizing of gas shocks or air bags may comprise: a. providing a hand held unit; b. attaching a high pressure gas source to the hand held unit; c. attaching the hand held unit to an object to be pressurize; d. activating a high pressure valve allowing a flow of a high pressure flow of gas from the high pressure gas source to a pressurized plenum in fluid connection with the object to be pressurized; and e. activating a vent valve allowing a flow of gas from the pressurized plenum to ambient atmosphere, thereby allowing the object to be deflated.

The method for hand held pressurizing of gas shocks or air bags above may further comprise monitoring the pressure of the object to be pressurized.

The monitoring the fill pressure step above may comprise using a pressure gage fluidly connected to the object to be pressurized.

A device may be capable of performing the steps of the method for hand held pressurizing of gas shocks or air bags above.

In yet another aspect of this invention, a hand held apparatus for pressurizing gas shocks or air bags may comprise: a. a high pressure inlet section, comprising: i. a high pressure valve that connects a highly pressurized gas source to a pressurized plenum, whereby a flow of high pressure gas from the highly pressurized gas source to the pressurized plenum is allowed; ii a high pressure valve actuator that can activate the high pressure valve; b. the pressurized plenum, comprising: i. a vent valve that connects the pressurized plenum to an ambient atmosphere, whereby a flow of gas from the pressurized plenum to the atmosphere is allowed; ii. a vent valve actuator that can activate the vent valve, thereby causing actuation of the vent valve.

In still another aspect of the invention, a hand held apparatus for inflating or deflating an object may be constructed, the hand held apparatus comprising: a. a high pressure port that fluidly connects a highly pressurized gas source to a pressurized plenum with a high pressure valve; b. a vent port that fluidly connects a vent valve to the pressurized plenum, the vent valve venting gas from the pressurized plenum to an external atmosphere; c. a gage port that fluidly connects to the pressurized plenum, wherein a gage attached to the gage port indicates the pressure of the pressurized plenum; d. a pressure output port fluidly connects to the pressurized plenum, wherein a change in pressure of the pressurized plenum reflects a change in pressure of an object to be inflated or deflated.

The ports of the hand held apparatus above may comprise a manifold.

The manifold may be comprised of a composition selected from a group of materials consisting essentially of: aluminum; fiberglass; a thermoplastic; and a thermoset plastic. The thermoplastic and thermoset plastics may both be foamed plastics when a foaming agent is added. Although aluminum is a likely choice of metals to use, other metals, such as copper, tin, steels, or titanium may be used, the only limitation being difficulties in fabrication and material cost. For ease of machining, low cost, and low weight, it is difficult to prefer any of the other alternative metals over aluminum.

The foamed plastics above may comprise a fiber filling with a weight percentage (Wt %) of fiber selected from the group of weight percentages consisting of: ≧1 Wt %, ≧2 Wt %, ≧5 Wt %, ≧10 Wt %, ≧15 Wt %, ≧20 Wt %, ≧30 Wt %, ≧40 Wt %, and ≧50 Wt %.

The fiber filling may be glass, carbon, or other relatively inexpensive fiber compatible with the plastic chemistries above.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a cross sectional view of a hand held apparatus for pressurizing gas shocks or other pneumatic devices.

FIG. 2 is a blown up section of the high pressure valve section of the hand held unit previously discussed in FIG. 1.

FIG. 3 is a cross-sectional view of the hand held unit body.

FIG. 4A is a bottom left perspective view of a machine hand held unit body without the pressure source or gage attached.

FIG. 4B is a top right perspective view of a machine hand held unit body without the pressure source or gage attached.

### DETAILED DESCRIPTION OF THE INVENTION

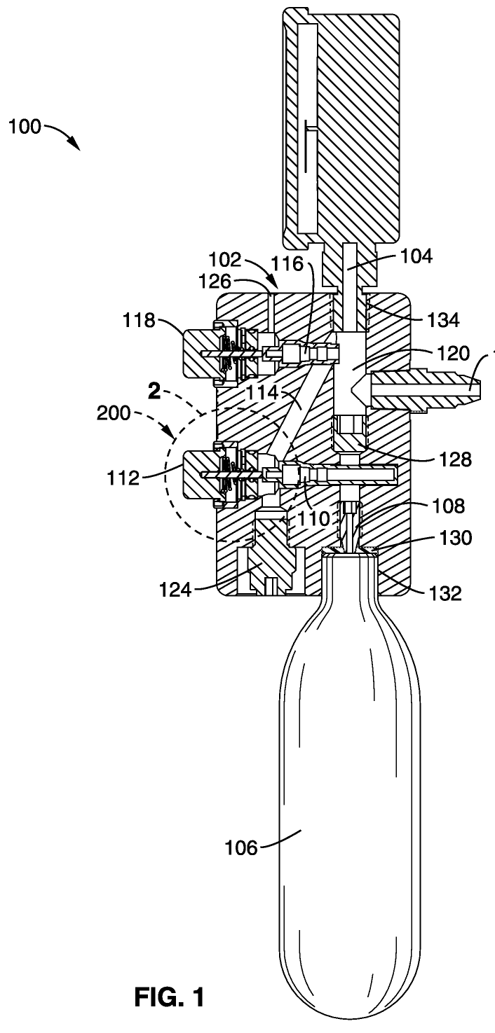

Referring more specifically to the drawings, for illustrative purposes the present invention is embodied in the apparatus generally shown in FIG. 1 through FIG. 4B. It will be appreciated that the apparatus may vary as to configuration and as to details of the parts, and that the method may vary as to the specific steps and sequence, without departing from the basic concepts as disclosed herein.

Pneumatic devices that provide lift and shock absorbing capacity are widely used world-wide. Frequently, these devices are filled with nitrogen gas, as this is substantially non-reactive relative to the materials (usually some sort of rubber) exposed to the gas. Dry air may be used, but it suffers from increase reactivity, hence oxidation. Simple compressed air suffers from the moisture that is ubiquitous in the atmosphere. Where non-dry air is used, reactivity may be increased over that of dry air, and the moisture may change state from gas to liquid or even solid, greatly changing the pressure of a confined sample of the air. For these reasons, and relatively low cost, nitrogen is a preferred filler for pressurized pneumatic devices such as gas shock absorbers (otherwise known as gas shocks) and “air bags” used for load levelling.

Refer now to FIG. 1, which is a cross-sectional view of a hand held gaged gas filling apparatus 100. Here, we find a hand held unit 102, which is attached to a monitoring gage 104 on one end, and a highly pressurized gas source 106 at the other end. A cartridge puncture device 108 is mounted within the hand held unit 102, which pierces the highly pressurized gas source 106.

Highly pressurized gas source 106 is shown as a bottle, and in reality it is a thin walled pressure vessel confining a pressurized gas. The gas may be CO₂, N₂, O₂, Ar, Xe, dry air, other dry gas, or any mixture of the preceding. Most likely, and most economically for filing pressurized components, the gas is N₂ or CO₂ gas.

A high pressure valve 110, which is actuated by a high pressure actuator 112, controls the release of the highly pressurized gas source 106 into a slanted portion 114 of a pressurized plenum. The pressurized plenum provides a source of pressurized gas controlled by vent actuator 118 by way of low-pressure vent valve 116. The vent actuator 118 in turn controls the release of gas from the pressurized plenum into ambient atmosphere.

A longitudinal portion 120 of the pressurized plenum is in fluid connection with the slanted portion 114 of the pressurized plenum. The pressurized plenum (comprised of slanted portion 114 and longitudinal portion 120) fluidly communicates with pressure gage 104 and to pressure outlet 122. Pressure outlet 122 is in turn connected to an object to be pressurized (not shown) through a pressure hose or other pressure containing tube. Thus, the pressure gage 104 indicates the pressure in the object to be pressurized. Ideally, the pressure gage 104 is fluid filled, and has a rather small orifice for pressure reading, so as to minimize fluctuations of the pressure gage 104 needle indicator, and thereby protect the needle from damage.

In operation, high pressure actuator 112 is depressed, allowing a flow of gas from the highly pressurized gas source 106 into the slanted portion 114 of the pressurized plenum. Gas released into the pressurized plenum equalizes with the pressure inside an object connected with the pressure outlet 122. Then the high pressure actuator 112 is released when the vicinity of a correct inflation pressure is indicated by the pressure gage 104.

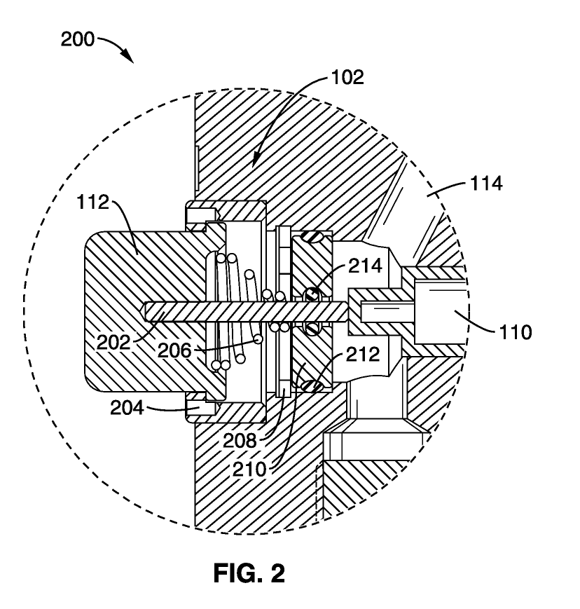

Due to the relative complexity of the high pressure actuator 112, a blowup 200 of the actuator is further described in FIG. 2 below.

Should the pressure indicated by the pressure gage 104 be too high, then the vent actuator 118 is depressed, allowing a flow of gas through a small diameter vent 126 from the slanted portion 114 of the pressurized plenum and from the object to be pressurized by the pressure outlet 122. By controlling the flow exiting the vent 126 to ambient atmosphere, the pressure in the object may be carefully and precisely achieved.

In fabrication, high pressure valve 110 has a preferred rating of 2000 psi, and vent valve 116 has a preferred pressure rating of 500 psi. A relief valve 124 is threaded into the hand held unit 102 to provide pressure relief of plenum 114 for conditions exceeding 400 psi. The relief valve serves to also protect the pressure gage 104 from over pressure conditions that might otherwise be achieved through incorrect operation of the device, or blocking of the pressure outlet 122 to the object to be inflated. The highly pressurized bottle 106 is recessed 132 into the hand held unit 102 to minimize inadvertent disconnection. Further, the pressure gage 104 is attached to the hand held unit 102 through a threaded engagement.

Seal 128 may be used to separate the high pressure region behind the cartridge puncture device 108 from the slanted 114 and longitudinal 120 portions of the pressurized plenum. This seal 128 may be used when the hand held unit 102 is machined from a solid to minimize machining operations and consequent fabrication costs.

Highly pressurized gas source 106 may be nitrogen supplied from a replaceable 95 cm³ cartridge style bottle that is approved for shipment via common carrier through the United States Department of Transportation (US DOT). A standard cartridge seal 130 is used to seal the high pressure gas source 106 to the hand held body 102.

Refer now to FIG. 2, which is a blown up section 200 of the high pressure valve 110 region of the hand held unit 102 previously discussed in FIG. 1. Here, the high pressure actuator 112 translates an actuator shaft 202 where the high pressure actuator 112 is retained by detent 204 and has conical spring return 206 acting to return it from depression.

Interior circular clip 208 retains a pressure seal 210 which seals pressure in the slanted portion 114 of the pressurized plenum via large O-ring 212 to the hand held unit 102, and to the actuator shaft 202 via small O-ring 214. Both of these O-rings 212 and 214 are greased with silicone grease to minimize gas leakage from the slanted portion 114 of the pressurized plenum to ambient atmosphere outside the hand held unit 102. Although not shown here, the vent actuator 118 actuates the low-pressure valve 116 in a similar fashion, but without an analog to the pressure seal 210 to the pressurized plenum being necessary.

Actuator shaft 202 is a ground and polished pin, with a highly smooth surface finish, allowing a low leak and reliable high pressure seal with small O-ring 214.

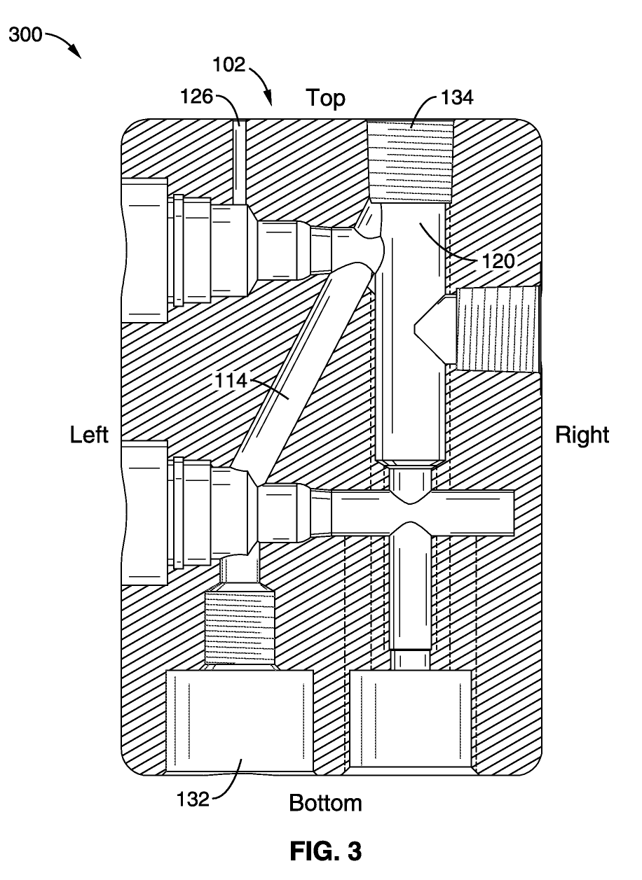

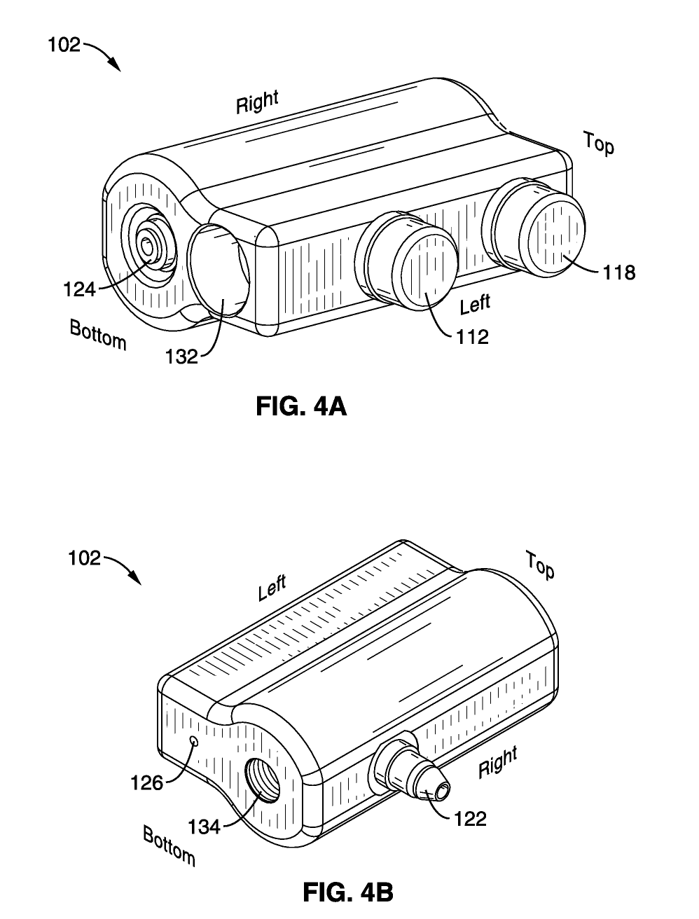

Refer now to FIG. 3, which is a cross-sectional view of the hand held unit 102. Here, the Top, Bottom, Left and Right sides are indicated for ease of comparison in subsequent FIGS. 4A and 4B. For clarity's sake, all hardware contained within and attached to hand held unit 102 has been removed. This cross-section is useful for understanding the unitary design of the hand held unit 102. Here, a block of metal, or high strength plastic, may be formed into the hand held unit 102. By high strength plastic, glass filled polycarbonate would be a likely candidate. If machined from a metal, aluminum would be a likely hand held unit 102 material.

In operation, the palm of the hand presses against the Right side, and the fingers operated the high pressure and vent actuators previously described on the left side. To make the hand held unit 102 more ergonomically comfortable, the Right side is larger to better conform to the palm of the hand.

Refer now to FIG. 4A, which is a bottom left perspective view of a hand held unit 102 with just the actuators and no other hardware attached.

For rapid filling of an object to be pressurized, the high pressure actuator 112 is continuously depressed, so long as the monitoring pressure gage 104 (previously shown in FIG. 1) does not indicate an over-pressure condition on the object to be pressurized. Should the hose attached to the object to be pressurized be constricted, then the relief valve 124 operates to vent the pressurized plenum (previously shown in FIG. 3). In this manner, the relief valve 124 protects the pressure gage 104 (previously shown in FIG. 1).

In this view, the recess 132 for the highly pressurized bottle 106 (previously shown in FIG. 1) is visible on the bottom side of the hand held unit 102. Also visible are the high pressure actuator 112 and the vent actuator 118 on the left side.

Refer now to FIG. 4B, which is a top right perspective view of the hand held unit 102. In this view, we see the threaded region 134 where the pressure gage 104 (previously shown in FIG. 1) is installed. Also, vent 126 is seen. Since vent 126 is on the top of the hand held unit 102, it is easily heard when in the process of venting pressure. Pressure outlet 122 is shown here as a traditional high pressure disconnect, but it may be any other pressure fitting.

Refer now to FIGS. 1-4B, it may be seen that the hand held gaged gas filling apparatus 100 may easily fit in the palm of a person's hand, and may be readily used for pressurizing and depressurizing objects connect to it through the pressure outlet 122. Although here a highly pressurized gas source 106 is principally described, a more traditional pressure quick connect may be used as the filling gas source, allowing fill gas up to very high pressures to be used.

A common issue in the inflation and deflation of tires, shocks, and other pneumatic objects is that upon filling, the pressure is overshot, and must be reduced. However, in the process of reducing the pressure, the pressure is not easily measured without further pressure loss through reconnection of a pressure gage. Here, if pressure is overshot, the vent actuator is depressed, allowing a very controlled deflation of the object, with constant monitoring of the object inflation pressure.

Although the hand held gaged gas filling apparatus 100 is small enough to be easily hand held, it may be permanently or semi-permanently attached to allow for quick inflation and deflation of items such as pneumatic shock absorbers.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A hand held apparatus for pressurizing an object, comprising:
an object to be pressurized; and
means for pressurizing the object.

2. The apparatus of claim 1, wherein the object to be pressurized comprises one or more of a group of objects consisting of: a pneumatic gas shock, a tire, a brake line, and an air bag.

3. The apparatus of claim 1, wherein the object is substantially pressurized with a gas.

4. The apparatus of claim 3, wherein the gas is selected from a group of gasses consisting essentially of: helium, argon, nitrogen, argon, carbon dioxide, air, a refrigerant, and one or more of the preceding.

5. The apparatus of claim 1, wherein the means for pressurizing the object comprises:
a hand held unit comprising:
an attachment to the object to be pressurized at a pressure outlet; and
an attachment to a highly pressurized gas source.

6. The apparatus of claim 5, wherein the hand held unit comprises:
a vent valve that fluidly and displaceably connects a pressurized plenum to an ambient atmosphere, the pressurized plenum fluidly connected to the pressure outlet;
a vent actuator that displaces the vent valve, thereby causing actuation of the vent valve with a consequent flow of gas from the pressurized plenum to the atmosphere; and
a high pressure inlet section, comprising:
a high pressure valve fluidly and displaceably connected between the highly pressurized gas source and the pressurized plenum, whereby a flow of high pressure gas from the highly pressurized gas source to the pressurized plenum is allowed during actuation of the high pressure valve; and
a high pressure valve actuator that displaces the high pressure valve, thereby causing displacement and actuation of the high pressure valve.

7. The apparatus of claim 6, further comprising:
a pressure gage capable of indicating the pressure of the object to be pressurized in fluid connection with the pressurized plenum.

8. The apparatus of claim 1, further comprising:
a pressure gage capable of measuring the pressure of the object to be pressurized and attached to the means for pressurizing the object.

9. The apparatus of claim 1, wherein the means for pressurizing the object comprises:
a pressure gage capable of indicating the pressure of the object to be pressurized.

10. The apparatus of claim 1, wherein the means for pressurizing the object comprises:
means for inflating the object to be pressurized; and
means for deflating the object to be pressurized.

11. A method for hand held pressurizing of gas shocks or air bags, comprising:
providing a hand held unit;
attaching a high pressure gas source to the hand held unit;
attaching the hand held unit to an object to be pressurize;
activating a high pressure valve allowing a flow of a high pressure flow of gas from the high pressure gas source to a pressurized plenum in fluid connection with the object to be pressurized; and
activating a vent valve allowing a flow of gas from the pressurized plenum to ambient atmosphere, thereby allowing the object to be deflated.

12. The method of claim 11, further comprising:
monitoring the pressure of the object to be pressurized.

13. The method of claim 12, wherein monitoring the pressure comprises:
using a pressure gage fluidly connected to the object to be pressurized.

14. A device capable of performing the steps of the method of claim 11.

15. A hand held apparatus for pressurizing gas shocks or air bags, comprising:
(a) a high pressure inlet section, comprising:
a high pressure valve that connects a highly pressurized gas source to a pressurized plenum, whereby a flow of high pressure gas from the highly pressurized gas source to the pressurized plenum is allowed; and
a high pressure valve actuator that can activate the high pressure valve; and
(b) the pressurized plenum, comprising:
a vent valve that connects the pressurized plenum to an ambient atmosphere, whereby a flow of gas from the pressurized plenum to the atmosphere is allowed; and
a vent valve actuator that can activate the vent valve, thereby causing actuation of the vent valve.

16. A hand held apparatus for inflating or deflating an object, the hand held apparatus comprising:
a high pressure port that fluidly connects a highly pressurized gas source to a pressurized plenum with a high pressure valve;
a vent port that fluidly connects a vent valve to the pressurized plenum, the vent valve venting gas from the pressurized plenum to an external atmosphere;
a gage port that fluidly connects to the pressurized plenum, wherein a gage attached to the gage port indicates the pressure of the pressurized plenum; and
a pressure output port fluidly connects to the pressurized plenum, wherein a change in pressure of the pressurized plenum reflects a change in pressure of an object to be inflated or deflated.

17. The apparatus of claim 16, wherein the ports of the hand held apparatus comprising a manifold.

18. The apparatus of claim 17, wherein the manifold comprises a composition selected from a group of materials consisting essentially of aluminum, fiberglass, a thermoplastic, and a thermoset plastic.

19. The apparatus of claim 17, wherein the manifold comprises a foamed thermoset plastic.

20. The apparatus of claim 18, wherein the manifold comprises a foamed thermoplastic.

21. The apparatus of claim 18, wherein the foamed thermoplastic comprises a fiber filling with a weight percentage (Wt %) of fiber selected from the group of weight percentages consisting of: ≧1 Wt %, ≧2 Wt %, ≧5 Wt %, ≧10 Wt %, ≧15 Wt %, ≧20 Wt %, ≧30 Wt %, ≧40 Wt %, and ≧50 Wt %.

22. The apparatus of claim 21, wherein fiber filling is glass or carbon.
